(19) United States
(12) Patent Application Publication
(10) Pub. No.: US 2016/0232989 A1
(43) Pub. Date: Aug. 11, 2016

(54) ENERGIZING ENERGY CONVERTERS BY STIMULATING THREE-BODY ASSOCIATION RADIATION REACTIONS

(71) Applicant: Tionesta Applied Research Corporation, Sequim, WA (US)

(72) Inventors: Anthony ZUPPERO, Pollock Pines, CA (US); Thomas J. DOLAN, Urbana, IL (US); William David JANSEN, San Diego, CA (US); William J. SAAS, Weslake, OH (US)

(21) Appl. No.: 14/880,799

(22) Filed: Oct. 12, 2015

Related U.S. Application Data
(63) Continuation of application No. 13/959,591, filed on Aug. 5, 2013, now abandoned.
Application No. 13/959,591 is a continuation-in-part of application No. 13/646,693, filed on Oct. 6, 2012, now abandoned.
(60) Provisional application No. 61/680,236, filed on Aug. 6, 2012.

(51) Int. Cl. G21B 3/00; G21D 7/04

(52) U.S. Cl. CPC G21B 3/006; G21D 7/04; G21Y 2002/601

(57) ABSTRACT

In some embodiments, energy is released by converting the bonding potential energy between two electropositive masses capable of forming a stable bond between them into the kinetic energy of an electron quasiparticle initially captured between them by the coulomb potential. The electron quasiparticles form transient bonds with delocalized ions and other reactants in or on a reaction particle where reaction rates and branches are controlled by the choice of electron quasiparticle effective mass. Methods and apparatus for stimulating and controlling such association reactions are shown and described. Thermionic and semiconductor methods and apparatus convert the electron quasiparticle energy directly into electricity. Other embodiments are disclosed.

### CROSS-REFERENCE TO RELATED APPLICATIONS

This application claims the benefit of U.S. Provisional Application No. 61/680,236, filed Aug. 6, 2012.

This application is also a continuation-in-parts of U.S. patent application Ser. No. 13/646,693, filed Oct. 6, 2012. U.S. Provisional Application No. 61/680,236 and U.S. patent application Ser. No. 13/646,693 are incorporated herein by reference.

### FIELD OF THE INVENTION

This invention relates generally to systems and methods of controlling the rate and branch of three-body association radiation reactions, and relates more particularly to using such apparatus and methods of controlling three-body association radiation reactions to generate electricity.

### DESCRIPTION OF THE BACKGROUND

In a particular association radiation reaction, two energetic reactants with an electron quasiparticle electrostatically trapped between them form a product and impart energy to the electron. The known, current state of the art does not correctly understand this particular reaction process, nor do existing systems and methods use this reaction process to create electrical energy or other useful purposes.

Accordingly, a need or potential for benefit exists for an apparatus or method that can use this particular reaction process.

### BRIEF DESCRIPTION OF THE DRAWINGS

To facilitate further description of the embodiments, the following drawings are provided in which:

FIG. 1 illustrates a diagram of a system or apparatus for generating three-body association radiation reactions, according to a first embodiment;

FIG. 2 illustrates a diagram of a reaction that occurs when using the system or apparatus of FIG. 1, according to the first embodiment;

FIG. 3 illustrates examples of the configuration of the positive-negative-positive entities, according to the first embodiment;

FIG. 4 illustrates an example of an electron electrostatically trapped between two positives entities, according to the first embodiment;

FIG. 5 illustrates a table of examples of three-body reactions that can be understood by using a three-body association reaction model, according to the first embodiment;

FIG. 6 illustrates an example of a potential energy diagram of a bond potential, according to the first embodiment;

FIG. 7 illustrates an example of two-dimensional model of the sequence of activities leading to a charge ejection in a three-body association radiation reaction, according to the first embodiment;

FIG. 8 illustrates an exemplary segment of a band structure diagram highlighting addition of energy and crystal momentum to place electron quasiparticles near an inflection point, according to the first embodiment;

FIG. 9 illustrates an example of increasing an effective mass can result in switching states from an “OFF” state to “ON” state, according to the first embodiment;

FIG. 10 illustrates a table listing some proton isotope association reaction candidates, according to the first embodiment;

FIG. 11 illustrates a table listing some deuteron isotope association reaction candidates, according to the first embodiment;

FIG. 12 illustrates a table listing some multi-deuteron pair association candidate examples, according to the first embodiment; and

FIG. 13 illustrates a flow chart for an embodiment of a method 1300 to generate three-body association radiation reactions using one or more lattice particles.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein.

The terms “couple,” “coupled,” “couples,” “coupling,” and the like should be broadly understood and refer to connecting two or more elements or signals, electrically, mechanically and/or otherwise. Two or more electrical elements may be electrically coupled but not be mechanically or otherwise coupled; two or more mechanical elements may be mechanically coupled, but not be electrically or otherwise coupled; two or more electrical elements may be mechanically coupled, but not be electrically or otherwise coupled. Coupling may be for any length of time, e.g., permanent or semi-permanent or only for an instant.

“Electrical coupling” and the like should be broadly understood and include coupling involving any electrical signal, whether a power signal, a data signal, and/or other types or combinations of electrical signals. “Mechanical coupling” and the like should be broadly understood and include mechanical coupling of all types.

The absence of the word “removably,” “removable,” and the like near the word “coupled,” and the like does not mean that the coupling, etc. in question is or is not removable.

The use of the word “conductor,” when used as a property of a lattice particle or a substrate, on which lattice particles are placed, refers either to a metallic conductor or to a semiconductor or insulator material that is stimulated to be a conductor. Stimulation can be by many methods, such as by irradiating the material with photons that populate the conduction band with electrons or by heating a doped semiconductor sufficient to ionize the electron donor dopant.

### DETAILED DESCRIPTION OF EXAMPLES OF EMBODIMENTS

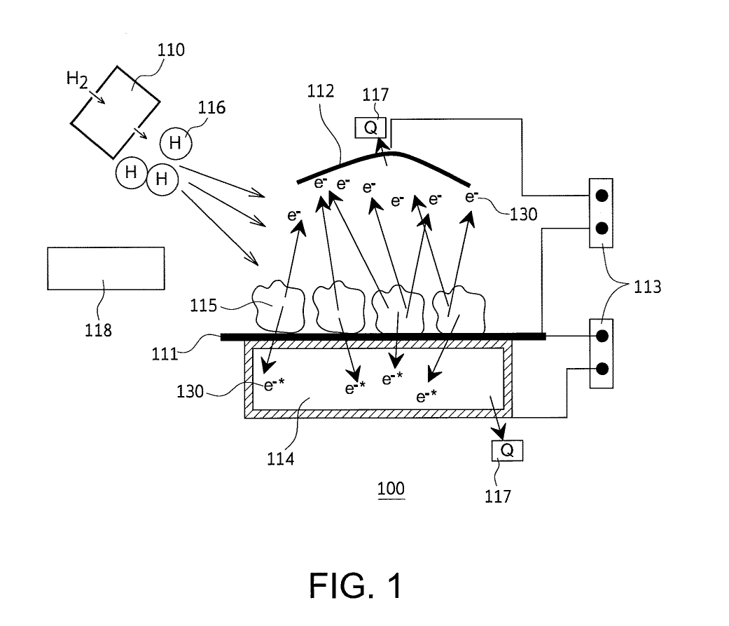

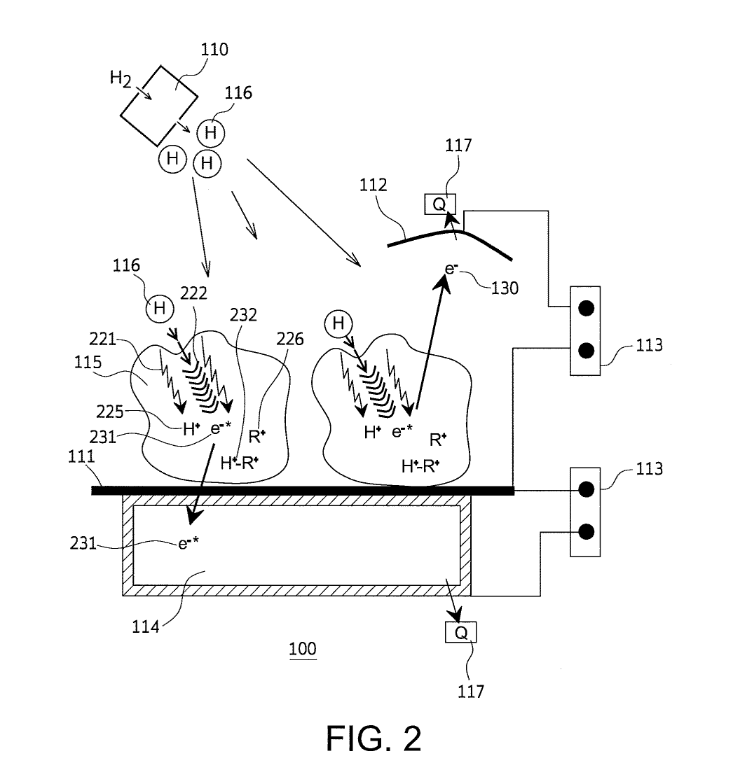

Turning to the drawings, FIG. 1 illustrates a diagram of a system 100 for generating three-body association radiation reactions, according to a first embodiment. FIG. 2 illustrates another view of a portion of system 100 and further illustrates a reaction that occurs when using system 100, according to the first embodiment. System 100 is merely exemplary and is not limited to the embodiments presented herein. System 100 can be employed in many different embodiments or examples not specifically depicted or described herein.

In some embodiments, system 100 can be configured to generate three-body association radiation reactions and also generate electrical energy. System 100 can include (a) at least one lattice particle 115 where the reactions occur; (b) at least one conducting substrate 111 electrically coupled to the lattice particle 115; (c) at least one reactant generator 110 configured to produce a flow of reactants 116 (e.g., gaseous ionic hydrogen isotope reactants and/or atomic hydrogen isotope reactants) and direct the flow of reactants at lattice particles 115; (d) at least one energy converter 112 (i.e., an electron collection device) configured to convert radiated electron energy into electrical energy and further configured to receive the radiation energy emitted from lattice particles 115; (e) at least one energy converter 114 electrically coupled to lattice particles 115 through substrate 111 and further configured to receive the radiation energy emitted from lattice particles 115; and (f) a deposition device 118 used to deposit lattice particles 115. In some examples, energy converter 112 and energy converter 114 can be electrically coupled to output electrical power at terminals 113. In some examples, lattice particle 115 can be a nanometers-dimensional lattice particle.

In some embodiments, the three-body association radiation reactions only occur when a participating electron has acquired sufficient effective mass. Some embodiments control the effective mass by immersing the electron in a conductor and energizing the electron with particular minimum values of both energy and momentum.

Not to be taken in a limiting sense, in a simple example of system 100, a deposition device 118 can be used to deposit lattice particles 115 on a surface of substrate 111. Next, atomic hydrogen atoms 116 (i.e., H or H+) are fired at lattice particle 115. As shown in FIG. 2, hydrogen atom 116 is energetically absorbed into lattice particle 115, releasing energy 221 and also generating a wave of momentum (e.g., crystal momentum) 222 as it energetically impacts into lattice particle 115. The collision causes a hydrogen atom 116 to lose its electron and to freely travel through lattice particle 115 as a roaming, bare ion 225. The wave of momentum 222 and energy 221 energize electron 231 with elevated effective mass, making a “heavy electron.” When the electron encounters a reactant 226, the hydrogen bare ion 225 reacts and the reaction pumps the bond energy into the “heavy” electron 231. This leaves the reaction product 232 stable and with practically no energy. The energetic electron 231 moves into energy converter 114, and can produce electricity in a manner similar to a photovoltaic device. Energetic electrons 130 can also escape from lattice particles 115 and/or substrate 111. These energetic electrons 130 are collected by energy converter 112 (e.g., an anode plate) and also generate electricity, similar to a vacuum thermionic diode electric generator.

In some examples, reactant generator 110 can produce atomic hydrogen by: (a) heating cracking materials, such as platinum, tungsten, tantalum, and iridium, at a temperature of 1500 K (Kelvin) or higher; (b) by passing an electric current through hydrogen gas; (c) energizing hydrogen gas with microwaves or electromagnetic radiation; and/or (d) using electrolytes. In other examples, reactant generator 110 can be a glow discharge device, an arc, or a particle accelerator.

In the same or different example, conducting substrate 111 can itself be photovoltaic semiconductor material. In other examples, conducting substrate 111 can be a one- or few-atom sheet of thermally and electrically conducting material (e.g., grapheme and/or dichalcogenides), and may also be tailored to be a semiconductor energy converter.

Energy converter 112 can be, for example, a thermionic vacuum diode or a device configured to efficiently convert electrons with a distribution of energies into useful electric output. In further examples, energy converter 112 can be a semiconductor energy converter. In various embodiments, energy converter 112 can be a material whose size or volume changes when energized by an energetic electron or x-ray, producing mechanical energy. In another example, energy converter 112 can be a material that sustains excited states or a population inversion useful for producing radiation. In still another example, energy converter 112 can be a material that simply expands or explodes when energized, providing a means to energize gasses or working fluids, to energize rocket propellant, hydraulic devices and gas turbine engines.

Semiconductor energy converter 114 can be any one of many known devices that convert electron or electromagnetic radiation into a voltage. Examples include metal-insulator-metal junctions such as Ta—TiO₂—Ta junctions (where Ta is tantalum and Ti is titanium), p-type Schottky photovoltaic diodes, thermionic Schottky diodes, and multi-layer pin diodes.

A heat sink 117 associated with system 100 is shown figuratively in FIGS. 1 and 2. Heat sink 117 can be coupled to energy converters 114, 112 and in some embodiments, to reaction particles 115.

In some examples, deposition device 118 can be electron beam deposition device, CVD (chemical vapor deposition) device, sacrificial carriers of deposition materials, or a thermal evaporator device. In various embodiments, deposition device 118 can deposit a monolayer of lattice particles 115 on a surface of substrate 111.

In various examples, the combination of the three particles—a roaming, bare ion 225, a “heavy electron” 231 and reactant 226—form an associated product 232 and undergo the three-body association radiation reaction. The ejected energetic electron 130 can be considered to be the three-body association reaction radiation in some examples.

The stimulated three-body association reaction is a novel concept that may be somewhat unfamiliar to those doing surface physical chemistry and/or catalytic reaction research. The stimulated three-body association reaction may occur on the scale of molecular chemistry and/or on the scale of nuclear interactions.

Research on surface chemical reactions has revealed an unexpected direct transfer of highly energetic, molecular vibration energy to a single electron. The energy of the moving electron is from the energy of internal vibration of the molecule. The conversion left the molecule with almost no vibrational energy. In some cases, practically all the available reaction energy was imparted to the single electron, leaving the chemical product in the ground state. Some people viewed the process as impossible because the change in vibrational quantum number for the transition was greater than one or two, thereby apparently violating quantum transition rules. However, this process does not violate the quantum transition rules because the transition is between vibration and electronic states, which is allowed.

This process has been poorly understood. Some computer simulation attempts to understand the process to be an electronic friction between energized molecule and electrons of a conductor surface. Another uses a quantum defect theory. A third uses a perturbation of three-body potentials. Contrasting these complex or computational models, a simple three-body association reaction can be designed to make, use, and explain the reaction. The result can be a direct extraction of electricity from the energetic starting constituents.

Four forces act on the three bodies (two positive particles and a negative electron quasiparticle):
(1) Coulomb repulsion between positive particles;
(2) Coulomb attraction between quasiparticle electrons and positive particles, which is stronger than the positive particles' repulsion;
(3) Heisenberg repulsion of electron quasiparticles confined and compressed between positive particles; and/or
(4) Strong nuclear forces (only at very short separations of positive particles).

In some examples, the potential between molecules, atoms, ions, or nuclei with relatively positive affinity may form a stable bond even without an electron quasiparticle trapped between them. The electron Heisenberg pressure prevents collapse of the system and limits the minimum separation distance. If the effective electron mass m* increases, then this distance decreases.

When an electron is confined between two positive objects the Heisenberg uncertainty of its momentum, Δp, at small separation distances, Δx leads to an effective outward pressure, which we call the “Heisenberg pressure.” This pressure limits the minimum separation distance between reactants and prevents collapse.

Some traditional theories argue that an elevated electron effective mass can enable two-body association reactions, but these theories do not reveal accepted physics and chemistry that would produce reactants associated into a product in or near the ground state, as observed experimentally. None of these theories assert the role of electron itself as the primary recipient of the reaction energy.

No prior art system controls or proposes to control effective mass by adding delocalization energy dL to reactants, crystal momentum (dk), and electron energy (dE) to conducting electrons of a lattice particle within or upon which reactants associate. No known prior art controls association reactions by moving electron quasiparticles to the vicinity of an inflection point of the band structure by injecting quasiparticle dk and dE.

Moreover, traditional systems do not show how energizing with gas phase, mono-atomic specie and/or reactants can provide conditions causing a stimulated three-body association radiation reaction.

### Three-Body Association Reactions with Molecular Bonding

Consider a widely separated pair of reactants thermally at rest that can form a bond without regard to any electron between them. The energy difference between separated reactants and product ground state, E_{R}, is the maximum reaction energy available. With the reactants initially far apart, the entire available reaction energy E_{R} is all potential energy, and the potential well depth equals E_{R}.

Now let the two reactants also be electropositive, such as oxygen or nitrogen atoms, or such as carbon monoxide (CO) and oxygen (O) and each adsorbed on a metal catalyst such as palladium (Pd) or platinum (Pt). Carbon monoxide is adsorbed on a surface of atoms in an “egg crate” pocket. An oxygen atom is adsorbed on an adjacent egg crate pocket. If a thermal electron finds itself between the oxygen (O) and the carbon monoxide, the thermal electron between them causes the reaction. The electron between them causes the carbon monoxide to smash into the oxygen, literally, because electron is negative, the carbon monoxide and 0 are positive, and they attract strongly. The “temperature” of the “smash” is approximately 20,000 to 30,000 degrees Kelvin. The three-body reaction gently dampens the smashing by using the electron as the damper. The damped electron now has all the energy and was squeezed out like slippery watermelon seed between fingers. The potential energy for these three bodies, an electron between two positives, is always attractive. This positive-negative-positive three-body configuration is the starting point and initial condition for a three-body association reaction.

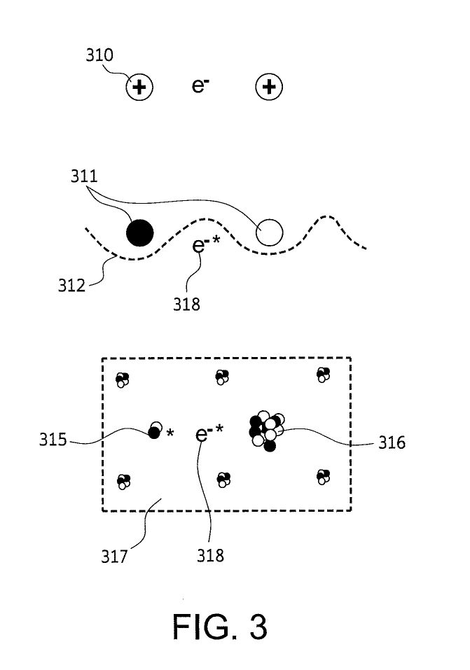

FIG. 3 illustrates figurative examples of the configuration of the positive-negative-positive entities when stretched to the largest dimension of their mutual motion. FIG. 3 shows protons 310 in free space, molecules 311 in their potential energy wells on the surface of a conducting substrate 312, and a roving (delocalized) nucleus 315 and a reactant nucleus 316 in a conductor 317. Roving (delocalized) entities are shown with an asterisk, such as the delocalized electron 318 and delocalized nucleus 315.

On a catalyst conductor surface, the electron may be a quasiparticle with an associated effective mass m*.

In the traditional description, the electron is trapped between positive particles, and the traditional result would be contraction and collapse to a point. However, the contraction motion is damped, stopped, and turned around by the electron between them, even though the electron quasiparticle is attracted to both positives. The quantum mechanical Heisenberg uncertainty in momentum associated with confining the electron between them acts like a pressure pushing against the contraction. The contraction is like the compression of a gas and raises the electron's quantum mechanical kinetic energy, its confinement energy. Energy is directly related to momentum.

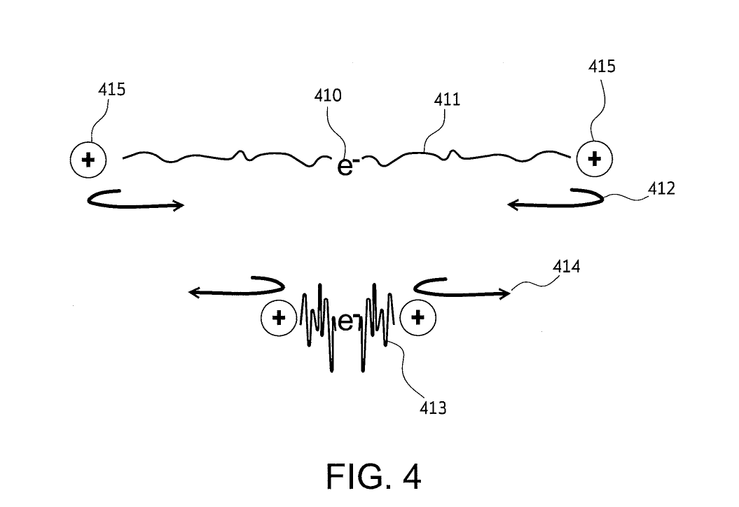

As shown in FIG. 4, the electron 410 is shown “stretched” with its lowest confinement energy 411 at its outer turning point 412 and “compressed” with its highest confinement energy 413 at its inner turning point 414. The expected value of the relative velocity of the reactants 415 approaches “zero” at the inner turning point 414.

If there were no other bond possible between the reactants, the three bodies would oscillate between this inner turning point 412 and an almost-dissociated, widely separated, outer turning point 412. At the inner turning point of the contraction, the electron has completely absorbed the contraction energy and completely stopped the motion of the two reactants towards each other. The electron's quantum confinement kinetic energy at the turning point equals the entire kinetic energy of the motion of the two massive reactants.

This interaction defines a highly vibrationally excited state in which the system begins.

### Bonding Potential

A simple model of two relatively positive entities associating through a bonding potential when an electron is placed between them shows that the electron can be ejected with most or all the available reaction energy. In a simple, instructive case, the product can be left in the ground state, in one energy transition.

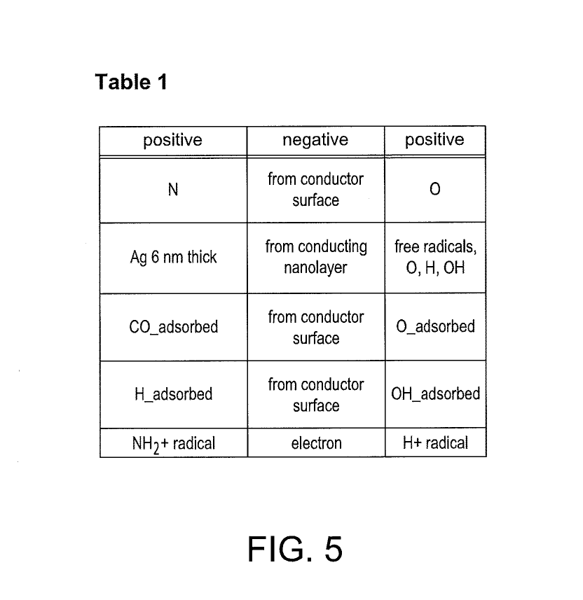

Table 1 of FIG. 5 lists some examples where molecular bonding occurs among three-body chemical systems.

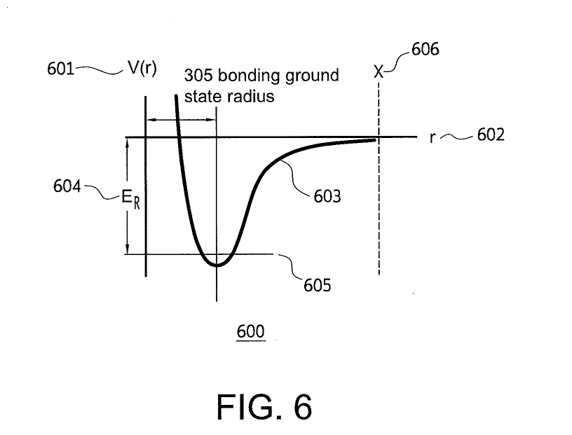

FIG. 6 shows a potential energy diagram of a bond potential 600 as a function of positive particles' separation distance. FIG. 6 illustrates the potential energy 601 versus separation distance, r, 602, and the variation of the bond potential 603 with r. The maximum reaction energy, E_{R}, 604 is from the separated positive entities at a nominal separation “X” 606 to the ground state 605.

A transition can occur at the inner turning point where the electron quasiparticle is ejected with the accumulated confinement energy. The bond between the two massive reactants is left with the remainder of the energy. This is what has been observed in multiple chemical systems, such as those shown in Table 1 of FIG. 5

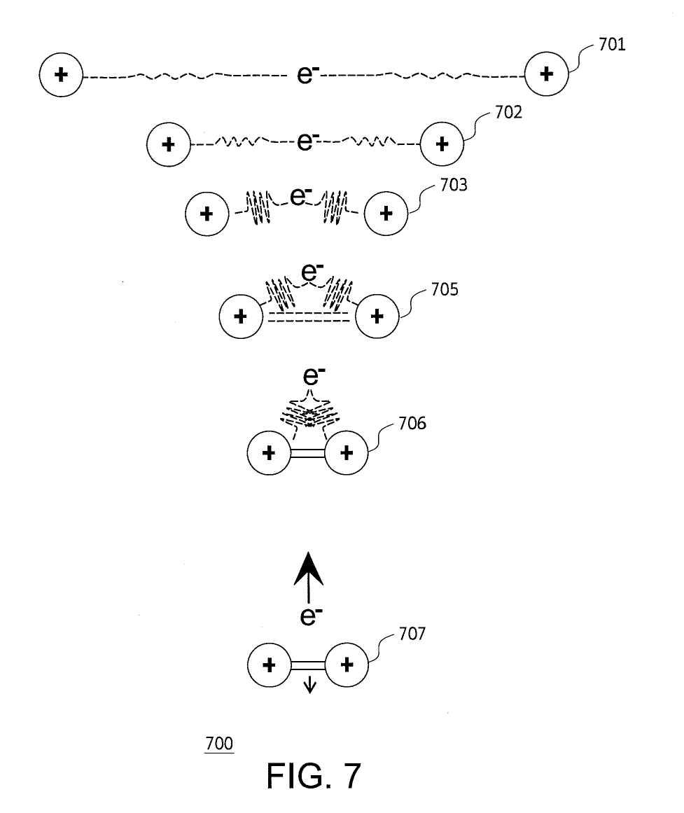

FIG. 7 illustrates a two-dimensional model of the sequence of steps leading to the electron ejection. Starting from a widely separated initial condition 701, the expected value of the position of the reactants 702 contracts due to the coulomb component of the attraction. The contraction would slow and eventually, turn around if there were no bond potential. In two dimensions, the electron may move away from the line between the positives 703. When the bond potential begins to take effect, it begins to pump quantum mechanical kinetic energy 705 into the electron. A transition occurs 706 when a bond forms independent of the electrons between the positives, and the electron is ejected.

If the confinement energy just equals the reaction energy of a bound state at this inner turning point 706, the electron can be ejected with the difference between the bond energy and the bound state energy.

The most interesting effect occurs when the Heisenberg confinement energy just matches and substantially equals the energy of the bonding potential's ground state. The novel result is that the product will be in the ground state. If the confinement energy substantially equals the reaction energy at the separation of the ground state 707, the associated product is left in the ground state and the electron has almost all the energy. The product moves in the opposite direction.

The starting point has all the energy as potential energy, and the end point has transferred the energy to kinetic energy of a single electron quasiparticle.

A relatively smaller residual energy is only the recoil energy of the massive, associated product relative to the ejected, energetic electron, to conserve momentum.

### Three-Body Association Reactions with Nuclear Bonding

In some embodiments, five components can be used in an electric generator embodiment using a nuclear bonding example:

1. Lattice particles (e.g., lattice particles 115 of FIG. 1). The lattice particles are usually conductors, such as nickel (Ni), tungsten, or palladium. The lattice particle could be semiconductors or even insulators, and would be stimulated to be transient conductors. In some examples, their nanoscale dimensions can satisfy the constraints described below;

2. Substrate (e.g., substrate 111 of FIG. 1). The substrate is chosen to provide an electrical contact to the lattice particle, a stable platform, and to facilitate energy conversion;

3. Isotope reactants (e.g., reactants 226 of FIG. 2). The isotope reactants can be any isotopes, which yield a positive energy gain, as discussed below. In some embodiments, the lattice elements themselves could function as reactants;

4. Delocalized reactants (e.g., H+ atoms 225 of FIG. 1). The delocalized reactants will usually be forms of hydrogen (meaning hydrogen, deuterium, or tritium) that are excited by energetic stimulation (discussed below), but they could also be isotope reactants or other reactants; and

5. A heat sink (e.g., heat sink 117 of FIG. 1) configured to maintain the substrate and/or the lattice particles at a predetermined temperature (e.g., less than 450 Kelvin).

A three-body association reaction can also occur when the heavy particles' separation distance becomes less than the range of the strong nuclear force. The minimum separation distance is controlled by the effective mass m* of the electron quasiparticle. Increasing m* reduces the separation distance. If this distance becomes small enough, the reaction is switched to the ON state.

A one-dimensional model reveals how to raise the electron quasiparticle effective mass, and turn ON the reaction, by moving the electron quasiparticle from its position near the Fermi level to the region of an inflection point of a band structure diagram of the conductor (i.e., lattice particle). Referring to the electron energy versus the crystal momentum curve, the effective electron mass m*= [symbol] ²/(∂²E/∂k²) where [symbol] is the reduced Planck constant, E is the energy, and k is the momentum. This curvature is zero at the inflection point. Therefore near the inflection point in one dimension, the effective mass m* can be very large. Thus, by controlling m* by providing electron crystal momentum dk, and energy dE to an electron of the conductor and thereby energizes it to approach an inflection point.

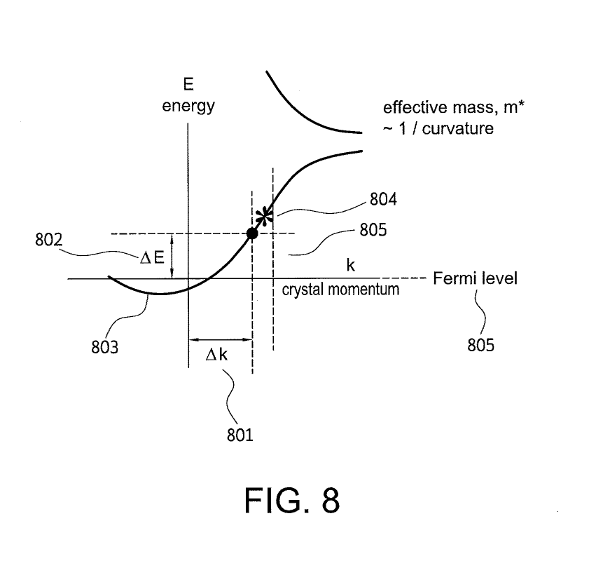

FIG. 8 shows a segment of an energy versus crystal momentum band structure. An electron with crystal momentum (Δk) 801 and energy (ΔE) 802 is near a locus of points 803 with a curvature. The inflection point 804 has zero curvature, and below it is positive curvature 806 and positive elevated effective mass. Adding Δk and ΔE to an electron near the Fermi level 805 places it in a region of lower curvature and higher effective mass. By providing the required ΔE and Δk, one can achieve an electron quasiparticle effective mass that is large and either positive or negative. Nearly all band structure diagrams have many places with zero curvature, especially near Brillouin zone boundaries.

### Control of Delocalization, Crystal Momentum, and Energy

In some examples, hydrogen ions can be trapped in local potentials in palladium and similar metals that hold hydrogen. The potential trap depth is sometimes low, of order 0.2 eV (electron-Volts) to 2 eV for palladium and similar hydrogen tank materials. To delocalize ions, thermal energy is added to surmount the traps. If the energy to escape the lattice particle is more than the delocalization energy, the delocalized ions satisfy the Bloch theorem and become a quasiparticle.

Referring again to FIG. 2, when atoms or molecules adsorb or desorb from a surface of lattice particle 115, the atoms or molecules impart a corresponding crystal momentum 222 (dk), which conserve momentum in the interaction. The adsorption energy provides energy 221 to the lattice 115, to electrons 231 (dE) and mobile reactant ions 225 (dL), delocalizing some of the electrons and/or ions. When appropriate values of dL, dk and/or dE are present simultaneously, a distribution of elevated effective mass electron quasiparticles m* and delocalized bare ion reactants results.

A delocalized reactant ion 225, which becomes an ion quasiparticle when it freely roams, encountering a distribution of elevated effective mass electron quasiparticles 231 can form the equivalent of an atom quasiparticle in a highly vibrationally excited state, and is stretched to its maximum in the conductor (e.g., the lattice particle). These atom quasiparticles are like excitons or atom-like bound states between a negative, real electron quasiparticle and a positive, real ion quasiparticle. This is analogous to electrons and holes in semiconductor physics.

The minimum separation distance of the newly formed atom quasiparticle (in one dimension) is inversely proportional to the electron quasiparticle effective mass m*. The atomic energy levels are also proportional to the effective mass, for example, the ionization energy and the condensation energy. These quasiparticles are in existence for only the lifetime of a normal electron quasiparticle in the conductor, insulator, or semiconductor, less than about 1×10⁻¹⁴ s.

### Condensation

One description of the resulting effect is that a fraction of the newly formed, transient atom quasiparticles experience microscopic chemistry along at least one dimension, with atom quasiparticle sizes smaller than normal atom sizes, and wherein the condensation temperature is raised proportional to the ionization energy. Analogous to exciton droplet formation in electron-hole systems, this real-mass “exciton” system may form transient liquids at temperatures elevated above the normal condensation temperatures by an amount proportional to the effective mass increase.

When a delocalized ion in a conductor encounters a distribution of elevated effective mass electron quasiparticles, the ion's electrons can be replaced by heavy electrons. Bare ion reactants 225 (FIG. 2) can therefore include any completely ionized atom. Energetic stimulation methods such as pulsed laser or electrical stimulation can create this environment.

Any method to increase the effective mass of an electron quasiparticle can cause a desired decrease in effective atom quasiparticle dimension and can greatly enhance tunneling probabilities between the atom quasiparticles and other reactants 226 (FIG. 2). This in turn permits the electron quasiparticle to find itself between positive reactants with a repulsive confinement energy less than the reaction energy E_{R}. This switches the state from “OFF” state to “ON” state, and enables the reaction.

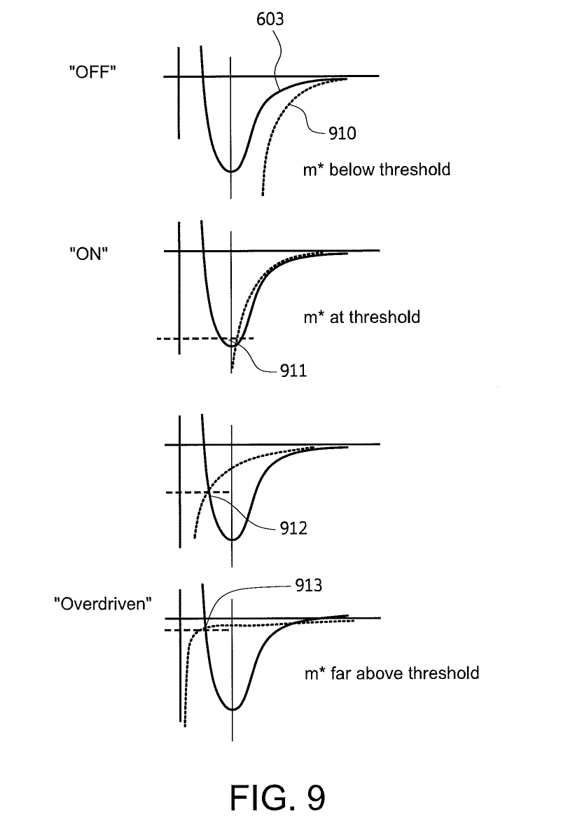

FIG. 9 schematically shows how increasing effective mass can result in switching states from “OFF” state to “ON” state. In FIG. 9, the Heisenberg confinement energy 910, 911, 912, 913 is plotted upside-down so that its values can be directly compared to the bond potential 603. When effective mass is below threshold, the repulsive confinement energy is far greater than the bond energy and therefore the required electron energy cannot be supplied by the bond. With low electron effective mass m* the state is shown “OFF”. To turn off the reaction or to maintain it off, reduce the effective mass m* below threshold.

When the effective mass is increased to threshold, the confinement energy is reduced and intersects the bond potential 603. The first opportunity to intersect is at the ground state 911. The electron energy is then equal to the reaction energy. When then effective mass is above threshold then the bond is at some excited state 912 and the electron has the remainder of the energy. When the effective mass is far above threshold the electron confinement energy is relatively small.

A threshold effective mass 911 is the lowest value of effective mass resulting in a confinement energy less than the reaction energy E_{R}. When a process produces a distribution of effective masses, the reaction will be turned ON at the first occasion the effective mass that is high enough to reduce the confinement energy to less than or equal to E_{R}.

A reaction between ion reactant participants in an association reaction then results in the association of the participants, transferal of the reaction energy to the electron quasiparticles trapped between them, and leaves the product(s) with the remainder of the energy.

The product will be in the ground state when the highest electron quasiparticle effective mass available from the distribution of effective masses results in confinement energy just equal to E_{R}.

As the effective mass becomes greater than the threshold, the probability of a product in an excited state increases.

### Materials Selection

One method to produce a stimulated three-body association reaction directs hydrogen or hydrogenic ions to flow into a lattice particle containing reactants that can associate with the hydrogen.

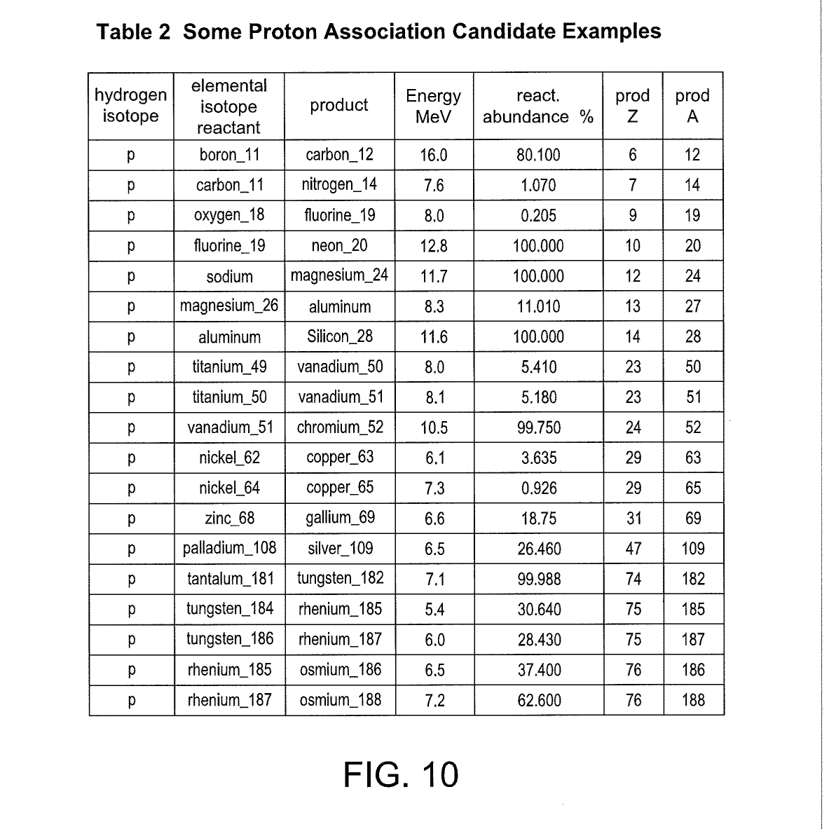

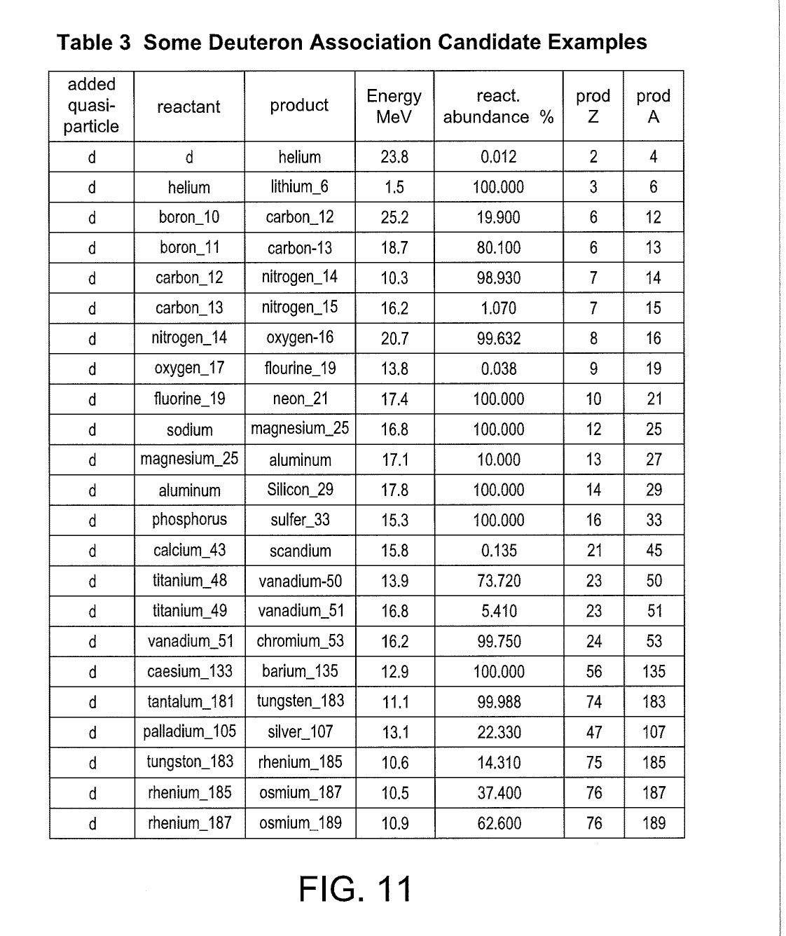

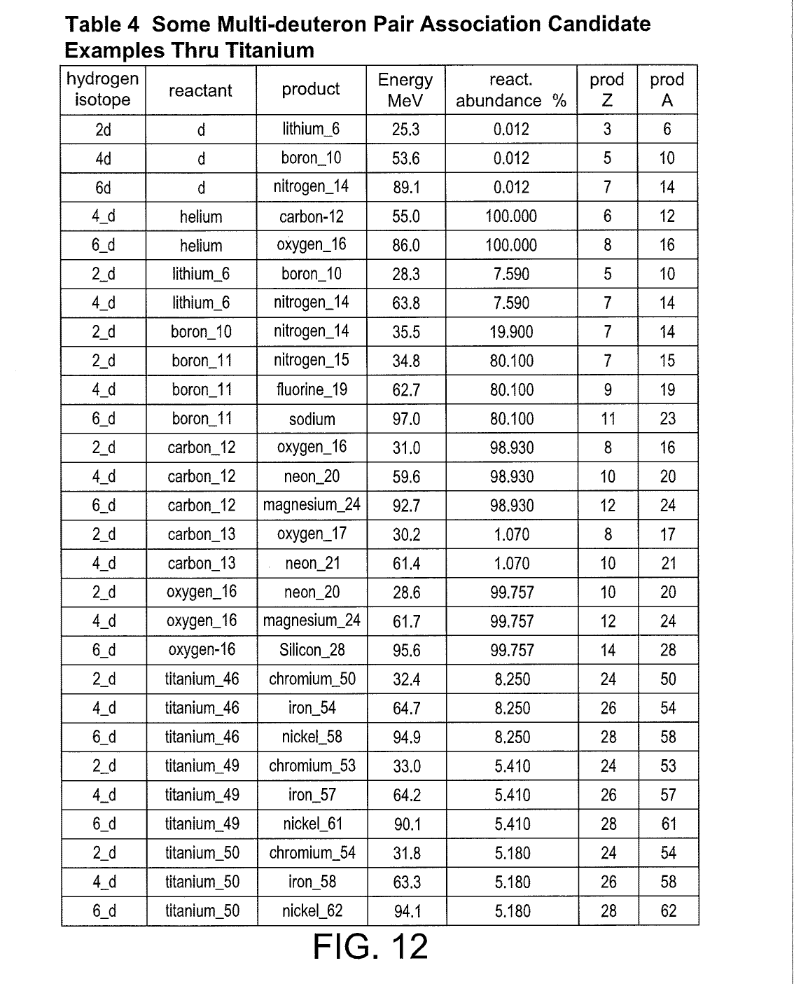

Some examples of elemental isotope reactants and isotopes in a lattice particle are given here in the form (hydrogen isotope, elemental isotope reactant, lattice particle). For example, (deuterium, deuterium, palladium) refers to the association of hydrogen isotope deuterium with elemental isotope deuterium in a palladium conduction particle. Some combinations include:
(deuterium, boron-10, and palladium),
(deuterium, carbon-12, and palladium),
(proton, boron-11, and palladium),
(proton, carbon-13, and palladium),
(proton, sodium, and palladium),
(deuterium, sodium, and palladium),
(proton, nickel-62, and nickel),
(proton, nickel-64, and nickel),
(proton, tantalum-181, and tantalum),
(deuterium, tantalum-181, and tantalum),
(proton, tungsten-184, and tungsten),
(proton, tungsten-186, and tungsten),
(deuterium, tungsten-183, and tungsten), and other combinations given in Table 2 of FIG. 10, table 3 of FIG. 11 and table 4 of FIG. 12.

In the tables of FIGS. 10-12, p and d represent a proton and deuteron, respectively, and 2d, 4d and 6d represent 1 pair, 2 pair and 3 pair of deuterons. In the tables of FIGS. 10-12, the product atomic number is depicted by “prod Z,” the product atomic weight by “prod A” and the reactant isotope natural abundance by “react. abundance %”.

The elemental isotopes include those that will associate with hydrogenic ions to yield a positive association energy. About half of the elements up to and beyond thallium will associate with one or more protons and/or deuterons and typically yield between 5 and 25 MeV. More than about 10% will associate with two, four, or six deuterons to give a stable elemental isotope, with energy release about 10 MeV per deuterium.

Elemental isotope reactants can include, and are not limited to, at least one of: protons, deuterons, and isotopes and elements lithium-7, beryllium, boron, carbon, nitrogen, oxygen-17, oxygen-18, fluorine, neon-21, neon-22, sodium, magnesium-25, magnesium-26, aluminum, silicon-29, silicon-30, phosphorous, sulfur-33, sulfur-34, sulfur-36, chlorine-37, argon-38, argon-40, potassium, calcium-43, scandium, titanium-48, titanium-49, titanium-50, vanadium-50, vanadium-51, chromium-53, chromium-54, manganese, cobalt, nickel-61, nickel-62, nickel-64, copper-63, copper-65, zinc-67, zinc-68, zinc-70, gallium-69, gallium-71, germanium-73, germanium-74, selenium-77, selenium-78, selenium-80, bromine-79, bromine-81, krypton-83, krypton-84, krypton-86, rubidium-85, rubidium-87, strontium-88, yttrium, zirconium-91, zirconium-92, niobium-93, ruthenium-102, rhodium-103, palladium-105, palladium-108, silver-107, silver-109, cadmium-111, cadmium-112, cadmium-113, cadmium-114, cadmium-111, cadmium-112, cadmium-113, cadmium-114, indium-113, indium-115, tin-119, tin-120, tin-122, antimony-121, antimony-123, tellurium-125, tellurium-126, iodine, xenon-131, xenon-132, caesium, barium-136, barium-137, barium 138, lanthanum-138, lanthanum-139, cerium-140, praesodymium-141, samarium-150, samarium-152, europium-151, europium-153, gadolinium-157, gadolinium-158, terbium-159, dysprosium-163, dysprosium-164, holmium-165, erbium-164, erbium-167, erbium-168, thulium-169, hafnium-178, hafnium-179, hafnium-180, tantalum-180, tantalum-181, tungsten-183, tungsten-184, tungsten-186, rhenium-185, rhenium-187, osmium-189, osmium-190, osmium-192, iridium-191, iridium-193, platinum-195, platinum-196, gold-197, mercury-201, mercury-204, thalium-203, thallium-205, lead-207, lead-208.

In various embodiments, the lattice particle can be metal, insulator, semiconductor, or quasi-crystal. It is only necessary that the addition of energy and crystal momentum to the electron quasiparticle that cause the electron quasiparticle to have an elevated or diminished effective mass. For example, an insulator or p-type semiconductor can respond like a conductor when energized with sufficient energy to place the electron in a conduction band.

In the same or different example, the particle size should be small enough and sufficiently isolated from its surroundings that the momentum waves associated with adsorption and absorption of the atomic hydrogen do not promptly dissipate into the surroundings or otherwise decay to heat. One way to achieve this condition is to use lattice particles on the surface of a substrate with a facet of a particle available to an atomic or ionic hydrogen isotope flow. Another method places lattice particles in contact with material having an impedance mismatch for vibrations between particle and surroundings. Other embodiments can suspend the lattice particles in a gas, for example, transiently in the volume of the firebox of a gas turbine engine or an explosion in a pulsed rocket.

In some examples, the smallest dimension of the particle can be less than three times the larger of:
the electron mean free path;
the mean free path of the highest energy optical phonon; or
the distance an electron would travel during a half period of the highest energy optical phonon (vibration).

Both phonon and electron mean free paths depend on energy in known ways. Alternatively and equivalently, the conductor particle shortest dimension is small compared with
the damping distance of the highest energy optical phonon; or
the distance an electron travels during the half-period of the highest frequency optical phonons.

In many cases, a smaller dimension is more favorable, resulting in higher electron energies and reaction rates.

In various examples, the lattice particle can absorb hydrogen and sustain a population of delocalized bare hydrogenic ions. Materials with hydrogen diffusivities higher than about 1×10⁻¹⁰ cm² per second or sufficient to allow the gaseous isotopes to become delocalized bare ion reactants in the conductor particle, are preferred, including Pd, Ni, Fe, (Iron) and Fe—Ni alloys, tungsten, compounds MgH₂, TiS₂, WSe₂, compounds sustaining bare ion flow in their lattice, conducting compounds used for hydrogen storage, LaNiHₓ and TeTiHₓ, where x is positive between 0 and about 2, and/or materials including one or more of lanthanum, praseodymium, cerium, titanium, zirconium, vanadium, tantalum, rhenium, uranium, hafnium and/or thorium

In one embodiment, the atomic hydrogen can be configured to enter the lattice particle faster than the atomic hydrogen can desorb from the lattice particle due to recombination. In one embodiment, the conductor particle has an outer region and an inner region. The outer region can include materials that are superpermeable to atomic hydrogen isotopes. The outer region can have an adsorption energy and recombination desorption barrier for atomic hydrogen, and the required adsorption energy is less than the recombination desorption barrier of atomic hydrogen of the lattice particle at a predetermined operating temperature (e.g., 450 Kelvin).

In one embodiment, the recombination barrier energy against hydrogen gas formation is greater than ˜0.2 eV. In other examples, similar to tungsten and tantalum, the recombination barrier energy against hydrogen gas formation is about two eV.

Superpermeable materials with high hydrogen isotope permeability can be lattice particle materials. The temperature of certain high permeability materials, such as tungsten (W) and tantalum (Ta), when facing an atomic hydrogen flow or when it is part of a particle coating, can be kept low enough to minimize recombination of H into H₂ and subsequent desorption. The optimum temperature depends on the material and is about 450 Kelvin for W and Ta.

The expected result includes the absorption of reactants into the lattice particle and adsorption onto the surface. These processes add delocalization energy, dL, crystal momentum, dk, and electron energy, dE. The lattice particle 115 (FIGS. 1 and 2) can include other elemental isotope reactants 226 (FIG. 2) besides hydrogen.

When an H atom collides with metal, its electron may be ejected by a chemical three-body association between the atom and the lattice particle. The ejected electron can be formed at the same time and location as the added crystal momentum dk and the injected delocalized, hydrogen isotope ion. This timing can increase efficiency and is not readily available in electrolysis systems, systems using molecular hydrogen, and atomic hydrogen systems such as electrolyte injections.

The criteria for choosing isotopes is that the total mass of the reaction products must be less than the total mass of the reacting isotopes, as in Table 2 of FIG. 10, table 3 of FIG. 11 and table 4 of FIG. 12.

The choice of materials relative to the permeation energy barrier depends on the situation. The desired injected crystal momentum and the concentration of bare ion reactants in a conductor can be a direct function of the permeation barrier to atomic hydrogen. In various embodiments, the relatively high, approximately two eV permeation barrier energy of tungsten and tantalum can be advantageous for crystal momentum injection. In another embodiment, the relatively low barrier energy of palladium is advantageous. In yet another embodiment, a few-monolayer coating of copper on a palladium or iron conductor particle provides a low barrier for absorption and high barrier against recombinative desorption, which concentrates hydrogen isotope. These are merely examples where the permeation barrier can be advantageous.

The expected result of the three-body radiation reaction is the emission of an electron quasiparticle. When electron collisions occur in the lattice particle, the electron energy may be distributed among many electrons comprising or coupled to the electron quasiparticle.

### Electron Energy Conversion

The average electron energy, E, is defined to be

E=E_{Re}/N

Where E_{Re} is the reaction energy carried by electrons (e.g., approximate E_{R} for threshold reactions), and N is the number of conduction electrons making up the electron quasiparticle (which is approximately the number of carrier electrons in the lattice particle with nanometer dimensions, for example). Lattice particles can have dimensions typically between approximately one and twenty nanometers.

When the bond potential corresponds to molecular reactions, E_{R} is in the eV range. When the nuclear strong force is dominant, then E_{R} is approximately five to twenty MeV (millions of electron-Volts). Observations of actual energies of x-rays and the lack of the familiar atomic energy level K or L radiation (i.e., atomic energy level, common index for highest (K) and next highest (L) energy series of atom) from atoms suggests the number of conduction electrons per atom is about two, the particle size is two to fifteen nanometer, resulting in a range of electron energies in the range approximately 0.1 eV to 5000 eV.

In most examples, energy converters can require a heat sink for thermodynamic reasons and to prevent excessive temperatures. Accordingly, the substrates can have a portion where a heat sink can be thermally coupled. A heat sink can also maintain the reaction particle at a temperature where recombination and desorption of absorbed hydrogen is acceptable. In some materials such as tungsten and tantalum, this temperature is of order 450 Kelvin. Note that for clarity the heat sink 117 is shown only figuratively in FIG. 1 or FIG. 2.

Diode converters can be located such that an electron quasiparticle escaping from the conductor particle encounters few atom layers of material before reaching the diode converters. The number of atom layers of the chosen materials should be low enough that many of the electrons escaping from the conductor particle have enough energy to charge the associated energy converter. The acceptable number of atom layers depends on the material and the electron energy, where lower atomic mass is better.

In an embodiment, one or more diode energy converters can covert electron or x-ray radiation energy into electrical potential energy. Each of the converters can have a radiation threshold energy for energy conversion. In one embodiment, the path between the lattice particle emitting an energetic electron and the energy converter has a material thickness chosen so that it does not decrease the electron or radiation energy too much for effective energy conversion, e.g. converting 1% or more of total available energy is acceptable.

When electron energies are as low as about 0.1 eV, the energy converter can be an n-type substrate formed as a Schottky diode with an appropriate barrier, or p-n junction with appropriate bandgap, with the lattice particles on the metal side, or p side, of the diode. The diode junction can become charged to a forward bias less than the “hot” electron energy, and the number of hot electron energies add up to E_{R}, and the reaction energy, diminished by the inefficiencies of the process. Forming the substrate Schottky diode from a semiconductor with electron effective mass m* greater than or approximately two, such as TiO₂, is an efficient way to capture the energy of these so-called hot electrons.

When the energies are above the band gap energy of an energy conversion semiconductor, a p-n junction diode or a p-type Schottky barrier diode may be used as the energy converter substrate. The lattice particle is on the p side or metal side of the junction, and the hot electron energizes the valence band electron to the conduction band. Diffusion transports the energized electron to the intermediate and n regions of the diode where the junction internal field then separates the charges exactly as in a photovoltaic device. A sufficiently high reaction rate can maintain a population inversion in a p-type semiconductor, which implies energy extraction can be by laser action, especially in direct bandgap materials such as GaN. This favors p-side electron injection.

The lattice particles can be placed on the n side or in the region between n and p. The placement is an engineering choice depending at least on geometry, electron mobility and the conductivity of the lattice particle layer.

When the energies are above the work function of the lattice particle, some electrons may be emitted into the vacuum, and a vacuum thermionic diode may be used to convert the energy into a potential. The vacuum diode electrodes must be separated enough to prevent electrical breakdown at high voltages.

When the energies are above the ionization energy associated with the semiconductor diode, multiple ionizations can occur in a semiconductor diode, and the multiple electron-hole pairs (e-h pairs) are converted to a voltage across the diode, as in a photovoltaic cell. Each converter semiconductor material has a threshold electron energy for energy conversion, where the ionization energy is one measure of the threshold

In some examples, the substrate would operate at elevated temperatures as high as 800 Kelvin. In some examples, a semiconductor substrate can be used. For examples, semiconductors substrates that can be used can include silicon carbide, SiC, GaN, GaP, and ZnO. SiC is known to have a useful bandgap in excess of 2.5 eV and to have useful semiconductor properties up to at least 800 K. Agglomeration of nanoparticles can be prevented by temperature control and by coating the particles with materials that do not adhere to each other.

A technique to convert MeV electron energies into a distribution compatible with a semiconductor includes an environment where an energetic electron collides with and distributes the energy into many electrons with lower energy (comparable to ionization energies and bandgap energies) For example, metal-semiconductor Schottky diodes, such as Pd/n-type TiO₂ diodes, Pd/n-type Silicon and Pd/n-type SiC, can use energies approximately one electron-Volt.

### Atomic Hydrogen

In some examples, reactant generator can generates atomic hydrogen efficiently, upon command, at temperatures compatible with semiconductor energy converters In many embodiments, reactant generator can be located in same physical volume as energy converter,

In various embodiments, the reactant generator could use the following techniques to produce atomic hydrogen:
(1) by heating cracking materials, such as platinum, tungsten, tantalum, and iridium, to greater than approximately 1500 K;
(2) by passing an electric current through hydrogen gas;
(3) by energizing hydrogen gas with microwaves or electromagnetic radiation;
(4) by photon-induced dissociation;
(5) by using electrolytes; and/or
(6) by using tiny particles placed within tunneling distance from each other and exposed to an environment of hydrogen.

In technique (6), when energy is applied (such as from a laser beam or electrical current) the electron temperature of the particle can become of order five times higher than the particle itself, and absorbed hydrogen may be desorbed from the particles.

Lattice particles having a shortest dimension as previously described are placed on an insulating substrate. The particles are placed with an average spacing between them such that tunneling is the dominant conduction mechanism between them. When the particles include a material that is known to adsorb atomic hydrogen and emit atomic hydrogen, the hot electron bath stimulates that emission. The emission temperature is below that of electrical or thermal means. The steady state temperature of the electrons can become about five times hotter than the temperature of the atoms in the particle, providing the energy to desorb atomic hydrogen. This method can also energize lattice particles to react with coating materials to inject crystal momentum and energy, stimulating three-body association reactions.

In these embodiments, hydrogen isotope reactants can be loaded into the reaction particle by any of many methods. For example, an oxide coating can be provided during one phase, hydrogen injection in another phase and energizing in another phase. Oxygen can be added and removed from palladium by heating and cooling phases and exposure to oxygen gas.

Channels conveying the atomic hydrogen should be made from materials that are not reactive with the hydrogen including such materials such as SiO₂ and non-metals. Some materials, such as graphene, adsorb monoatomic hydrogen in less than nanoseconds and release it over minutes, suggesting its use to transport atomic hydrogen from its source to the lattice reactant particle. This would mitigate the gas pressure, temperature, and impurity issues. Faraday screens, charged neutralizer plates can be used to separate atomic from ionic hydrogen.

Monoatomic sheets such as graphene, MoS₂, WSe₂ and WS₂, and some hydrogen storage materials, can provide both a few-atom substrate and in some configurations a semiconductor energy converter. Such materials can also exhibit heat sink and electrical conduction properties. Lattice particles placed on a mono-atomic or few-atom thick sheet of material may then emit the electrons into the space surrounding the sheet. Here, the sheet then provides one or a few atoms between conductor particle and energy converter, and the sheet must conduct electricity. Graphene is an example of such a sheet. The sheets are known to be configurable as photovoltaic converters. In this case, the sheet itself is an energy converter.

Forms of graphene, dichalcogenides, and other materials, have been known to adsorb atomic hydrogen and desorb atomic hydrogen over a period of minutes. This property can be used to transport atomic hydrogen from where it is produced at a higher gas pressure and temperature to another location where conductor particles reside at lower gas pressure and temperature. For example, atomic hydrogen isotope atoms can be generated in one location and physically transport them to another location where they directed on to the lattice particles. One embodiment uses a rotating disc with a graphene surface. On one side, a source directs atomic hydrogen on to the graphene where they are absorbed. This region may be at a high temperature. As the disc turns to it faces reaction particles in a colder region where atomic hydrogen isotopes desorb on to the lattice particles. An embodiment can use the disc itself as the anode of a thermionic vacuum diode. In an embodiment, the disc can include energy converters.

When energy of electron quasiparticle exceeds thermal, the three-body system may find itself unbounded. In the unbounded system, the electron is not trapped in the potential and may deliver energy to the associating products, forming new products.

An exemplary system to initiate pulsed reactions includes a collection of conductor particles including elemental isotope reactants, a filler material that vaporizes when energized by electricity or other means, a generator of atomic hydrogen isotope that responds on electrical or other command and configured to flood a region of gas containing the conductor particles. The vaporizing is configured to produce a region of gas transiently suspending the conductor particles while not destroying all the particles. Upon energizing the filler material, the lattice particles become suspended in the resulting gas, the gas expands, and after the gas has expanded, a generator of atomic hydrogen isotope is energized, flooding the region of gas with reactants, causing absorption atomic hydrogen isotope, conversion of isotope to bare ion reactants in the conductor, and thereby initiating pulsed stimulated three-body association radiation reactions.

An embodiment resulting in pulsed reactions uses particles containing materials that are superpermeable to hydrogen and configured as a dust of particles with size limitations as described previously. A reactant combination includes deuterium as the delocalized bare ion reactant and deuterium as the elemental isotope. Another combination includes a proton with the carbon 12 isotope, or a deuteron with carbon 13 isotope, or a proton with the boron 11 isotope, or a deuteron with the boron 12 isotope, or with a deuteron with a tungsten and/or tantalum isotope. These represent only a few of many examples.

An exemplary embodiment uses reaction particles coated at least in part with oxides. When some energy source induces a reaction with hydrogen isotope within the particle with oxygen outside the particle, the energy released by the reaction injects energy. The energy can contribute to delocalization of bare ion reactants, to injection of crystal momentum due to abstraction of the hydrogen to form a hydroxide, and to energizing an electron quasiparticle. The energy source can be any one of many known in the art, for example, by electrolysis, laser beams, and/or electrical stimulation.

When an energy converter includes a direct bandgap semiconductor, the energy released by a stimulated three-body reaction may be sufficient to cause emission of electromagnetic radiation or a population inversion. The inversion can be used to convert the energy into electromagnetic radiation.

In some examples, the injection of energy and crystal momentum by any method can maximize formation of a transient, simultaneous distribution inside the conductor particle of delocalized bare ion reactants or atomic hydrogen isotopes and delocalized electron quasiparticles having crystal momentum and energy values at least equal to the crystal momentum and energy values of an inflection point above the Fermi Level within the first Brillouin zone of the energy versus momentum band structure of the conductor particle.

One method achieves reaction initiation by conveying gaseous atomic hydrogen directly to a facet or region of the lattice particle surface. The surface is made of materials that are superpermeable to atomic hydrogen isotopes, wherein the activation barriers against adsorption and absorption are lower than the barriers for diatomic hydrogen. In the some lattice particles, adsorbing or absorbing atomic hydrogen injects delocalization energy, dL, crystal momentum, dk, and electron quasiparticle energy, dE simultaneously.

Another method uses lattice particles coated with other materials such as oxides, or immerses lattice particles in a region where delocalized reactant and other particles adsorb and desorb in response to electrical, thermal, or chemical energizing. The choice of other particle mass and absorption energy facilitates adjusting dk and dE to move the electron near an inflection point of the lattice particle band structure diagram. This stimulation can turn ON a three-body association reaction.

Some embodiments disclose an apparatus configured to generate three-body association radiation reactions. The apparatus can include: (a) one or more lattice particles located at a first region of at least one substrate, each of the one or more lattice particles having a shortest dimension across of less than twenty nanometers, the substrate configured as an electrical conductor and in electrical contact with the one or more lattice particles; (b) at least one reactant generator configured to produce a flow of reactants and direct the flow of reactants at the one or more lattice particles, the flow of reactants comprises at least one of gaseous ionic hydrogen isotope reactants or atomic hydrogen isotope reactants; and (c) a heat sink thermally coupled to the at least one substrate, the heat sink configured to help maintain the at least one substrate at a predetermined operating temperature.

The one or more lattice particles can include elemental isotope reactants and one or more delocalized electron quasiparticles. The one or more lattice particles can have a band structure. The band structure can describe energy of the one or more delocalized electron quasiparticles versus crystal momentum of the one or more delocalized electron quasiparticles. The band structure includes a Fermi level, a Brillouin zone along a crystal momentum axis, and one or more inflection points at one or more loci. The first region of the at least one lattice particle can include at least one surface region of the at least one substrate facing the flow of reactants. The one or more lattice particles further have a barrier energy for diatomic hydrogen dissociation and hydrogen recombination. The one or more lattice particles having at least one of: (a) a first permeability property for absorption of atomic hydrogen isotopes greater than 1×10¹² mols per meter-Pascal^{1/2}-seconds; or (b) a second permeability property for absorption of the atomic hydrogen isotopes such that gaseous atomic hydrogen isotopes are absorb directly into one of the one or more lattice particles of the at least one substrate with an activation energy less than either 2.2 electron volts or less than the barrier energy for the diatomic hydrogen dissociation and the hydrogen recombination. The one or more lattice particles further having a diffusion coefficient property either greater than 1×10⁻⁴ cm²/s or sufficient to allow the gaseous ionic hydrogen isotope reactants to become one or more delocalized bare ion reactants within the one or more lattice particles. The one or more lattice particles further having the property, after absorption of at least part of the flow of reactants, of maintaining a transient simultaneous distribution of: (a) the one or more delocalized bare ion reactants in the one or more lattice particles; and (b) the one or more delocalized electron quasiparticles with a crystal momentum at least equal to the crystal momentum of an inflection point of the one or more inflection points above the Fermi Level within the Brillouin zone of the band structure; and (c) the one or more delocalized electron quasiparticles with an energy value at least equal to the energy value of the inflection point of the one or more inflection points above the Fermi Level within the first Brillouin zone of the band structure. A distribution of the crystal momentum and the energy value of the one or more delocalized electron quasiparticles in the one or more lattice particles are such that a three-body association radiation reaction is generated between the one or more delocalized bare ion reactants and the elemental isotope reactant, and thus, energizing at least some of the one or more delocalized electron quasiparticles in the one or more lattice particles with sufficient kinetic energy to escape from the one or more lattice particles.

In some embodiments, each of the one or more lattice particles have a damping distance associated with the highest energy optical phonon of the lattice In the same or different examples, the shortest dimension of the one or more lattice particles is less than the larger of one-half of the damping distance, and of order of one-half the distance an electron travels during one-half of a period of the highest frequency associated with the highest energy photon.

In various embodiments, the one or more lattice particles comprise at least one of: Pd, Ni, Fe and Fe—Ni alloys, tungsten, compounds MgH₂, TiS₂, WSe₂, compounds, LaNiHₓ and TeTiHₓ, where x is a positive between 0 and about 2, or materials including one or more of lanthanum, praseodymium, cerium, titanium, zirconium, vanadium, tantalum, rhenium, uranium, hafnium or thorium.

The at least one reactant generator can be configured to produce the atomic hydrogen isotope reactants and direct the atomic hydrogen isotope reactants such that the atomic hydrogen isotope reactants enter the one or more lattice particles faster than the atomic hydrogen isotope reactants can desorb from the one or more lattice particles due to recombination. The one or more lattice particles can have an outer region and an inner region. The outer region of the one or more lattice particles can be superpermeable to the atomic hydrogen isotope reactants. The outer region of the one or more lattice particles can have an adsorption energy and recombination desorption barrier for the atomic hydrogen isotope reactants. The adsorption energy of the one or more lattice particles can be less than the recombination desorption barrier for the atomic hydrogen isotope reactants at the predetermined operating temperature. In the same or different embodiment, the one or more lattice particles can include one or more materials that are superpermeable to the atomic hydrogen isotope reactants at the predetermined operating temperature.

In some embodiments, the recombination desorption barrier for the atomic hydrogen isotope reactants is greater than 0.2 electron-Volts.

In many embodiments, the elemental isotope reactants of the one or more lattice particles include at least one of boron, carbon, tungsten, tantalum, nickel, titanium, or palladium. In the same or different embodiment, the elemental isotope reactants include at least one of lithium-7, beryllium, boron, carbon, nitrogen, oxygen-17, oxygen-18, fluorine, neon-21, neon-22, sodium, magnesium-25, magnesium-26, aluminum, silicon-29, silicon-30, phosphorous, sulfur-33, sulfur-34, sulfur-36, chlorine-37, argon-38, argon-40, potassium, calcium-43, scandium, titanium-48, titanium-49, titanium-50, vanadium-50, vanadium-51, chromium-53, chromium-54, manganese, cobalt, nickel-61, nickel-62, nickel-64, copper-63, copper-65, zinc-67, zinc-68, zinc-70, gallium-69, gallium-71, germanium-73, germanium-74, selenium-77, selenium-78, selenium-80, bromine-79, bromine-81, krypton-83, krypton-84, krypton-86, rubidium-85, rubidium-87, strontium-88, yttrium, zirconium-91, zirconium-92, niobium-93, ruthenium-102, rhodium-103, palladium-105, palladium-108, silver-107, silver-109, cadmium-111, cadmium-112, cadmium-113, cadmium-114, cadmium-111, cadmium-112, cadmium-113, cadmium-114, indium-113, indium-115, tin-119, tin-120, tin-122, antimony-121, antimony-123, tellurium-125, tellurium-126, iodine, xenon-131, xenon-132, caesium, barium-136, barium-137, barium 138, lanthanum-138, lanthanum-139, cerium-140, praesodymium-141, samarium-150, samarium-152, europium-151, europium-153, gadolinium-157, gadolinium-158, terbium-159, dysprosium-163, dysprosium-164, holmium-165, erbium-164, erbium-167, erbium-168, thulium-169, hafnium-178, hafnium-179, hafnium-180, tantalum-180, tantalum-181, tungsten-183, tungsten-184, tungsten-186, rhenium-185, rhenium-187, osmium-189, osmium-190, osmium-192, iridium-191, iridium-193, platinum-195, platinum-196, gold-197, mercury-201, mercury-204, thalium-203, thallium-205, lead-207, or lead-208.

In some examples, the apparatus can further include a vacuum or gaseous region around the first region of the at least one substrate or around the one or more lattice particles.

In various embodiments, the at least one electron collection device is configured to convert electron or x-ray radiation energy into electrical energy and further configured to receive at least part of the at least some of the one or more delocalized electron quasiparticles that escape from the one or more lattice particles. The at least one electron collection device can have a predetermined radiation threshold energy for energy conversion from the electron or the x-ray radiation energy into the electrical energy. The at least one electron collection device can be spaced apart from the at least one substrate and the one or more lattice particles. The at least one electron collection device can include a vacuum thermionic diode and the at least part of the at least some of the one or more delocalized electron quasiparticles that have an energy above a cathode work function of the vacuum thermionic diode charge the vacuum thermionic diode.

In some examples, the apparatus can further include a photovoltaic diode. The photovoltaic diode can have an ionization energy and a band gap energy. The photovoltaic diode can be configured to convert energy above the ionization energy and a band gap energy of the at least one substrate from the at least one lattice particle into a voltage across the photovoltaic diode.

In many examples, the apparatus can further include a semiconductor diode converter coupled to the at least one substrate and configured to covert energy from the at least one lattice particle into electrical energy. For example, the semiconductor diode converter comprises silicon carbide.

The at least one semiconductor diode converter can be a p-type semiconductor material and the one or more lattice particles is coupled to the p-type semiconductor material which can also function as the substrate.

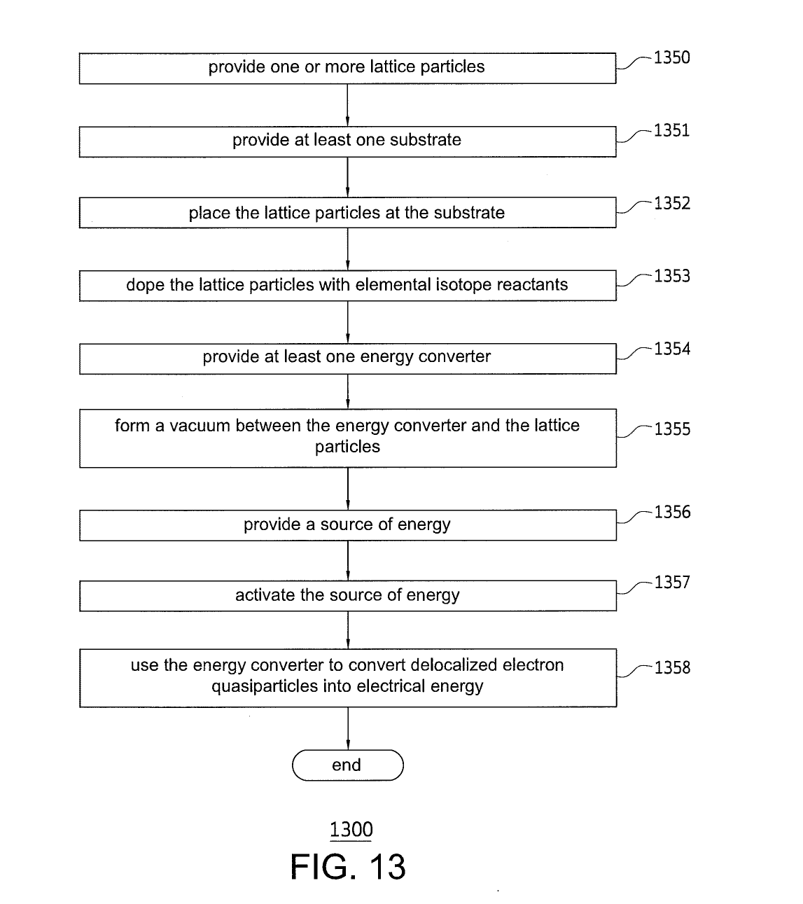

FIG. 13 illustrates a flow chart for an embodiment of a method 1300 to generate three-body association radiation reactions using one or more lattice particles. In some examples, at least part of method 1300 can also be considered a method to provide a device to provide stimulated three-body association radiation. Method 1300 is merely exemplary and is not limited to the embodiments presented herein. Method 1300 can be employed in many different embodiments or examples not specifically depicted or described herein. In some embodiments, the activities, the procedures, and/or the processes of method 1300 can be performed in the order presented. In other embodiments, the activities, the procedures, and/or the processes of method 1300 can be performed in any other suitable order. In still other embodiments, one or more of the activities, the procedures, and/or the processes in method 1300 can be combined or skipped.

Referring to FIG. 13, method 1300 includes an activity 1350 of providing one or more lattice particles. In some examples, the one or more lattice particles can have a first dimension across the one or more lattice particles of less than 20 nanometers where the first dimension is the shortest dimension across the one or more lattice particles. Furthermore, the one or more lattice particles having at least one of: a first permeability property for absorption of atomic hydrogen isotopes greater than 1×10¹² mols per meter-Pascal^{1/2}-seconds; or a second permeability property for absorption of the atomic hydrogen isotopes such that gaseous atomic hydrogen isotopes are absorb directly into one of the one or more lattice particles of the at least one substrate with an activation energy less than either 2.2 electron-Volts or less than the barrier energy for diatomic hydrogen dissociation and hydrogen recombination. The one or more lattice particles can further have a diffusion coefficient property either greater than 1×10⁻⁴ cm²/s or sufficient to allow the gaseous ionic hydrogen isotope reactants to become one or more delocalized bare ion reactants in the one or more lattice particles. The one or more lattice particles can include one or more delocalized electron quasiparticles and have a band structure, the band structure comprising a Fermi level, a Brillouin zone along a crystal momentum axis, and one or more inflection points at one or more loci. In the same or different examples, the one or more lattice particles are conductors.

In various embodiments, the one or more lattice particles can be similar or the same as lattice particles 115 of FIG. 1.

Method 1300 in FIG. 13 continues with an activity 1351 of providing at least substrate. In some examples, the substrate can be similar or the same as substrate 111 of FIG. 1.

Subsequently, method 1300 of FIG. 13 includes an activity 1352 of placing the lattice particles at the substrate. In some examples, the one or more lattice particles can be placed at the substrate such that: the one or more lattice particles are in electrical contact with the substrate and at least a part of the one or more lattice particles are located at a surface of the substrate such that the one or more lattice particle can accept a flow of reactants.

In some examples, the lattice particles can be deposited on the substrate. For example, the lattice particles can be placed on the substrate similar or identical to the placement of lattice particles 115 on substrate 111 of FIG. 1.

Next, method 1300 of FIG. 13 includes an activity 1353 of doping the lattice particle with elemental isotope reactants. In some examples, the one or more lattice particles are doped with elemental isotope reactants such that an association reaction between the one or more lattice particles and the elemental isotope reactants is exothermic. In other examples, activity 1353 is not necessary and skipped because the lattice particles already include a sufficient amount of elemental isotope reactants.

Method 1300 in FIG. 13 continues with an activity 1354 of providing at least one energy converter. In some examples, the energy converter can be similar or the same as energy converter 112 and/or energy converter 114 of FIG. 1.

Subsequently, method 1300 of FIG. 13 includes an activity 1355 of forming a vacuum between the energy converter and the lattice particles. In some embodiments, the vacuum has a pressure of less than 100 Pascals. For examples, the vacuum can be similar to a vacuum between lattice particles 115 and energy converter 112 of FIG. 1.

Next, method 1300 of FIG. 13 includes an activity 1356 of providing a source of energy. In some embodiments, the source of energy is configured to direct a flow of reactants at the one or more lattice particles such that the flow of reactants creates one or more delocalized bare ion reactants in the one or more lattice particles and after creating the one or more delocalized bare ion reactants, crystal momentum and energy is added to delocalized electron quasiparticle where the crystal momentum and energy added to the delocalized electron quasiparticles is at least 10% higher than the crystal momentum and energy of an inflection point of the one or more inflection points above the Fermi Level within the Brillouin zone of the band structure and a distribution of the crystal momentum and energy of the one or more delocalized electron quasiparticles in the one or more lattice particles is such that a three-body association radiation reaction is generated between the one or more delocalized bare ion reactants and the elemental isotope reactant, and thus, energizing at least some of the one or more delocalized electron quasiparticles in the one or more lattice particles with sufficient kinetic energy to escape from the one or more lattice particles to the energy converter.

In some examples, the source of energy can be similar or the same as reactant generator 110 of FIG. 1. The flow of reactants can be, for example, flow of reactants 116 of FIG. 1.

Method 1300 in FIG. 13 continues with an activity 1357 of activating the source of energy. In some examples, the source of energy directs the flow of reactants at the one or more lattice particles such that the flow of reactants creates the one or more delocalized bare ion reactants in the one or more lattice particles and after creating the one or more delocalized bare ion reactants, adds the crystal momentum and energy to the delocalized electron quasiparticle where the crystal momentum and energy added to the one or more bare ion reactants is at least 10% higher than the crystal momentum and energy of the inflection point of the one or more inflection points above the Fermi Level within the Brillouin zone of the band structure and the distribution of the crystal momentum and energy of the one or more delocalized electron quasiparticles in the one or more lattice particles is such that the three-body association radiation reaction is generated between the one or more delocalized bare ion reactants and the elemental isotope reactant, and thus, energizing the at least some of the one or more delocalized electron quasiparticles in the one or more lattice particles with sufficient kinetic energy to escape from the one or more lattice particles to the energy converter.

Subsequently, method 1300 of FIG. 13 includes an activity 1358 of using the energy converter to convert a part of the at least some of the one or more delocalized electron quasiparticles into electrical energy. After activity 1358, method 200 is complete.

Although the invention has been described with reference to specific embodiments, it will be understood by those skilled in the art that various changes may be made without departing from the spirit or scope of the invention. Accordingly, the disclosure of embodiments of the invention is intended to be illustrative of the scope of the invention and is not intended to be limiting. It is intended that the scope of the invention shall be limited only to the extent required by the appended claims. For example, to one of ordinary skill in the art, it will be readily apparent that the methods may be comprised of many different activities, procedures and be performed by many different modules, in many different orders that any element of FIG. 1 may be modified and that the foregoing discussion of certain of these embodiments does not necessarily represent a complete description of all possible embodiments.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. An apparatus configured to generate three-body association radiation reactions, the apparatus comprising:
one or more lattice particles, the one or more lattice particles located at a first region of at least one substrate, each of the one or more lattice particles having a shortest dimension across of less than twenty nanometers;
the at least one substrate, the at least one substrate is configured as an electrical conductor and in electrical contact with the one or more lattice particles;
at least one reactant generator configured to produce a flow of reactants and direct the flow of reactants at the one or more lattice particles, the flow of reactants comprising at least one of gaseous ionic hydrogen isotope reactants or atomic hydrogen isotope reactants; and
a heat sink thermally coupled to the at least one substrate, the heat sink configured to help maintain the at least one substrate at a predetermined operating temperature,
wherein:
the one or more lattice particles comprise elemental isotope reactants and one or more delocalized electron quasiparticles;
the one or more lattice particles have a band structure, the band structure comprising a Fermi level, a Brillouin zone along a crystal momentum axis, and one or more inflection points at one or more loci;
the one or more lattice particles have at least one surface region facing the flow of reactants;
the one or more lattice particles further having a barrier energy for diatomic hydrogen dissociation and hydrogen recombination;
the one or more lattice particles having at least one of:
a first permeability property for absorption of atomic hydrogen isotopes greater than 1×10¹² mols per meter-Pascal^{1/2}-seconds; or
a second permeability property for absorption of the atomic hydrogen isotopes such that gaseous atomic hydrogen isotopes are absorbed directly into one of the one or more lattice particles of the at least one substrate with an activation energy less than either 2.2 electron volts or less than the barrier energy for the diatomic hydrogen dissociation and the hydrogen recombination;
the one or more lattice particles further having a diffusion coefficient property either greater than 1×10⁻⁴ cm²/s or sufficient to allow the gaseous ionic hydrogen isotope reactants to become one or more delocalized bare ion reactants within the one or more lattice particles;
the one or more lattice particles further having a first property, after absorption of at least part of the flow of reactants, of maintaining a transient, simultaneous distribution of:
(a) the one or more delocalized bare ion reactants or one or more delocalized atomic hydrogen isotope reactants in the one or more lattice particles;
(b) the one or more delocalized electron quasiparticles with a crystal momentum at least equal to a crystal momentum of an inflection point of the one or more inflection points above the Fermi Level within the Brillouin zone of the band structure; and
(c) the one or more delocalized electron quasiparticles with an energy value at least equal to an energy value of the inflection point of the one or more inflection points above the Fermi Level within the first Brillouin zone of the band structure;
a distribution of the crystal momentum and the energy value of the one or more delocalized electron quasiparticles in the one or more lattice particles are such that a three-body association radiation reaction is generated between the one or more delocalized bare ion reactants and the elemental isotope reactants, and thus, energizing at least some of the one or more delocalized electron quasiparticles in the one or more lattice particles with sufficient kinetic energy to escape from the one or more lattice particles.

2. The apparatus of claim 1, wherein:
each of the one or more lattice particles having a damping distance associated with a highest energy optical phonon of that one of the one or more lattice particles;
the shortest dimension of the one or more lattice particles is less than the larger of one-half of the damping distance and an order of one-half the distance an electron travels during one-half of a period of a highest frequency associated with the highest energy optical phonon of that one of one or more the lattice particles.

3. The apparatus of claim 1, wherein:
the one or more lattice particles comprise at least one of: palladium, nickel, iron and Fe—Ni alloys, tungsten, compounds MgH₂, TiS₂, WSe₂, compounds, LaNiHₓ and TeTiHₓ, where X can be between zero and two, or materials including one or more of lanthanum, praseodymium, cerium, titanium, zirconium, vanadium, tantalum, rhenium, uranium, hafnium, or thorium.

4. The apparatus of claim 1, wherein:
the at least one reactant generator is configured to produce the atomic hydrogen isotope reactants and direct the atomic hydrogen isotope reactants such that the atomic hydrogen isotope reactants absorb into the one or more lattice particles faster than the atomic hydrogen isotope reactants can desorb from the one or more lattice particles due to recombination;
the one or more lattice particles having an outer region and an inner region;
the outer region of the one or more lattice particles is superpermeable to the atomic hydrogen isotope reactants;
the outer region of the one or more lattice particles having an adsorption energy and recombination desorption barrier for the atomic hydrogen isotope reactants,
the adsorption energy of the one or more lattice particles is less than the recombination desorption barrier for the atomic hydrogen isotope reactants at the predetermined operating temperature;
the outer region of the one or more lattice particles comprise the at least one surface region of the one or more lattice particles.

5. The apparatus of claim 4, wherein:
the elemental isotope reactants of the one or more lattice particles comprise at least one of boron, carbon, tungsten, tantalum, nickel, titanium, or palladium.

6. The apparatus of claim 4, wherein:
the one or more lattice particles comprise one or more materials that are superpermeable to the atomic hydrogen isotope reactants at the predetermined operating temperature.

7. The apparatus of claim 4, wherein:
the recombination desorption barrier for the atomic hydrogen isotope reactants is greater than 0.2 electron-Volts.

8. The apparatus of claim 1, further comprises:
a vacuum region around at least one of the one or more lattice particles.

9. The apparatus of claim 1, wherein:
the elemental isotope reactants comprise at least one of boron, carbon, nitrogen, tantalum-180, tantalum-181, tungsten-183, tungsten-184, or tungsten-186.

10. The apparatus of claim 1, further comprising:
at least one energy converter device configured to convert electron or x-ray radiation energy into electrical energy and further configured to receive at least part of the at least some of the one or more delocalized electron quasiparticles that escape from the one or more lattice particles.

11. The apparatus of claim 10, wherein:
the at least one energy converter device is spaced apart from the one or more lattice particles.

12. The apparatus of claim 10, wherein:
the at least one electron collection device comprises a vacuum thermionic diode; and
the at least part of the at least some of the one or more delocalized electron quasiparticles that have an energy above a cathode work function of the vacuum thermionic diode create a voltage across the vacuum thermionic diode.

13. The apparatus of claim 1, further comprising:
a semiconductor diode,
wherein:
the at least one semiconductor diode having an ionization energy; and
the semiconductor diode is configured to convert energy from the at least one three-body association radiation above an ionization energy from the one or more lattice particles into a voltage across the semiconductor diode.

14. The apparatus of claim 13, further comprising:
a semiconductor diode converter coupled to the at least one substrate and configured to convert energy emitted by the one or more lattice particles into electrical energy.

15. The apparatus of claim 14, wherein:
the semiconductor diode converter comprises silicon carbide.

16. The apparatus of claim 1, wherein:
the at least one substrate comprising a p-type semiconductor material; and
the one or more lattice particles are coupled to the p-type semiconductor material.

17. A method to provide a device, the device configured to generate stimulated three-body association radiation, the method comprising:
providing one or more lattice particles, where:
the one or more lattice particles have a first dimension across the one or more lattice particles of less than 20 nanometers, the first dimension is the shortest dimension across the one or more lattice particles;
the one or more lattice particles having at least one of:
a first permeability property for absorption of atomic hydrogen isotopes greater than 1×10¹² mols per meter-Pascal^{1/2}-seconds; or
a second permeability property for absorption of the atomic hydrogen isotopes such that gaseous atomic hydrogen isotopes are absorbed directly into one of the one or more lattice particles of at least one substrate with an activation energy less than either 2.2 electron-Volts or less than the barrier energy for diatomic hydrogen dissociation and hydrogen recombination; and
the one or more lattice particles further having a diffusion coefficient property either greater than 1×10⁻⁴ cm²/s or sufficient to allow the gaseous ionic hydrogen isotope reactants to become one or more delocalized bare ion reactants in the one or more lattice particles;
the one or more lattice particles comprise one or more delocalized electron quasiparticles and have a band structure, the band structure comprising a Fermi level, a Brillouin zone along an crystal momentum axis, and one or more inflection points at one or more loci; and
the one or more lattice particles are conductors;
providing at least one substrate;
placing the one or more lattice particles at the at least one substrate such that:
the one or more lattice particles are in electrical contact with the at least one substrate; and
at least a part of the one or more lattice particles are located at a surface of the at least one substrate such that the one or more lattice particle can accept a flow of reactants;
providing at least one energy converter;
forming a vacuum between the at least one energy converter and the one or more lattice particles where the vacuum has a pressure of less than 100 Pascals; and
providing a source of energy to delocalize the atomic hydrogen isotopes in the one or more lattice particles wherein: the source of energy is configured to direct a flow of reactants at the one or more lattice particles such that the flow of reactants creates one or more delocalized bare ion reactants in the one or more lattice particles and after creating the one or more delocalized bare ion reactants, crystal momentum and energy is added to the one or more delocalized electron quasiparticles where the crystal momentum and the energy added to the one or more delocalized electron quasiparticles is at least 10% higher than a crystal momentum and an energy of an inflection point of the one or more inflection points above the Fermi Level within the Brillouin zone of the band structure and a distribution of the crystal momentum and the energy of the one or more delocalized electron quasiparticles in the one or more lattice particles is such that a three-body association radiation reaction is generated between the one or more delocalized bare ion reactants and elemental isotope reactants, and thus, energizing at least some of the one or more delocalized electron quasiparticles in the one or more lattice particles with sufficient kinetic energy to escape from the one or more lattice particles to the at least one energy converter.

18. The method of claim 17, further comprising:
activating the source of energy to delocalize atomic hydrogen isotopes in the one or more lattice particles wherein: the source of energy directs the flow of reactants at the one or more lattice particles such that the flow of reactants creates the one or more delocalized bare ion reactants in the one or more lattice particles and after creating the one or more delocalized bare ion reactants, adds the crystal momentum and the energy to the one or more delocalized electron quasiparticles where the crystal momentum and the energy added to the one or more delocalized electron quasiparticles is at least 10% higher than the crystal momentum and the energy of the inflection point of the one or more inflection points above the Fermi Level within the Brillouin zone of the band structure and the distribution of the crystal momentum and the energy of the one or more delocalized electron quasiparticles in the one or more lattice particles is such that the three-body association radiation reaction is generated between the one or more delocalized bare ion reactants and the elemental isotope reactants, and thus, energizing the at least some of the one or more delocalized electron quasiparticles in the one or more lattice particles with sufficient kinetic energy to escape from the one or more lattice particles to the at least one energy converter; and
using the at least one energy converter to convert the one or more delocalized electron quasiparticles into electrical energy.

19. The method of claim 17, further comprising:
doping the one or more lattice particles with the elemental isotope reactants such that an association reaction between the one or more lattice particles and the elemental isotope reactants is exothermic.

20. A method to generate three-body association radiation reactions using one or more lattice particles, a source of energy, and at least one energy converter, the one or more lattice particles have a first dimension across the one or more lattice particles of less than 20 nanometers, the first dimension is the shortest dimension across the one or more lattice particles; the one or more lattice particles having at least one of: a first permeability property for absorption of atomic hydrogen isotopes greater than 1×10¹² mols per meter-Pascal^{1/2}-seconds; or a second permeability property for absorption of the atomic hydrogen isotopes such that gaseous atomic hydrogen isotopes are absorbed directly into one of the one or more lattice particles of at least one substrate with an activation energy less than either 2.2 electron-Volts or less than an barrier energy for diatomic hydrogen dissociation and hydrogen recombination; the one or more lattice particles having further having a diffusion coefficient property either greater than 1×10⁻⁴ cm²/s or sufficient to allow gaseous ionic hydrogen isotope reactants to become one or more delocalized bare ion reactants in the one or more lattice particles; the one or more lattice particles comprise one or more delocalized electron quasiparticles and have a band structure, the band structure comprising a Fermi level, a Brillouin zone along an crystal momentum axis, and one or more inflection points at one or more loci; and the one or more lattice particles are conductors, the method comprising:
activating the source of energy to delocalize the atomic hydrogen isotopes in the one or more lattice particles wherein: the source of energy directs the flow of reactants at the one or more lattice particles such that the flow of reactants creates the one or more delocalized bare ion reactants in the one or more lattice particles and after creating the one or more delocalized bare ion reactants, adds crystal momentum and energy to the one or more delocalized electron quasiparticles where the crystal momentum and the energy added to the one or more delocalized electron quasiparticles is at least 10% higher than a crystal momentum and an energy of the inflection point of the one or more inflection points above the Fermi Level within the Brillouin zone of the band structure and the distribution of the crystal momentum and the energy of the one or more delocalized electron quasiparticles in the one or more lattice particles is such that the three-body association radiation reaction is generated between the one or more delocalized bare ion reactants and elemental isotope reactants, and thus, energizing at least some of the one or more delocalized electron quasiparticles in the one or more lattice particles with sufficient kinetic energy to escape from the one or more lattice particles to the at least one energy converter; and
using the at least one energy converter to convert a part of the at least some of the one or more delocalized electron quasiparticles into electrical energy.
